(19) United States
(12) Patent Application Publication
(10) Pub. No.: US 2014/0013578 A1
(43) Pub. Date: Jan. 16, 2014

(54) Fastening device and method for producing a fastening device

(71) Applicant: Airbus Operations GmbH, Hamburg (DE)

(72) Inventor: Robert Alexander Goehlich, Hamburg (DE)

(21) Appl. No.: 14/031,883

(22) Filed: Sep. 19, 2013

Related U.S. Application Data
(63) Continuation of application No. PCT/EP2012/001100, filed on Mar. 12, 2012.
(60) Provisional application No. 61/466,492, filed on Mar. 23, 2011.

(30) Foreign Application Priority Data
Mar. 23, 2011 (DE) 10 2011 014 819.1

(51) Int. Cl. B64C 1/12; F16B 37/04

(52) U.S. Cl. CPC B64C 1/12; F16B 37/04
USPC 29/525.02; 411/85; 470/2

(57) ABSTRACT

A fastening device which is suitable, in particular, for use in aircraft construction includes a carrier which is composed of a rollable or foldable material and has a first surface, intended for abutting against a component to be connected to the fastening device, and a second surface opposite the first surface. A plurality of openings are formed in the carrier and pass through the carrier. The fastening device also includes a plurality of heads, each provided with an internal thread, which are connected to the carrier or formed integrally with the carrier and which extend in such a manner from the second surface of the carrier that the internal threads of the heads are aligned with the openings passing through the carrier.

### CROSS-REFERENCES TO RELATED APPLICATIONS

This application is a continuation of International Application PCT/EP2012/001100 filed Mar. 12, 2012, designating the United States and published on Sep. 27, 2012 as WO 2012/126583. This application also claims the benefit of the U.S. Provisional Application No. 61/466,492, filed on Mar. 23, 2011, and of the German patent application No. 10 2011 014 819.1 filed on Mar. 23, 2011, the entire disclosures of which are incorporated herein by way of reference.

### BACKGROUND OF THE INVENTION

The invention relates to a fastening device which is suitable, in particular, for use in aircraft construction and to a method for producing such a fastening device. Furthermore, the invention relates to an aircraft component equipped with such a fastening device and to a method for connecting such an aircraft component to a further aircraft component.

During the assembly, in particular assembly of the structure of an aircraft, customarily a large number of anchor nuts is installed. In particular, anchor nuts are used in assembly regions which are no longer accessible during the fitting of corresponding bolts to be screwed to the anchor nuts. Anchor nuts which are common at present comprise a head provided with an internal thread and fastened to a small carrier plate and are fixed individually to an aircraft structure component by means of rivets or ferrules passing through the small carrier plate or by an adhesive-bonded connection. On connecting the aircraft structure component to a further aircraft structure component, the anchor nuts can then cooperate with a corresponding screw bolt connecting the aircraft structure component and the further aircraft structure component to one another.

### SUMMARY OF THE INVENTION

The invention is directed to the object of providing a fastening device which is suitable, in particular, for use in aircraft construction and facilitates the connection of two components and of specifying a method for producing such a fastening device. Furthermore, the invention is directed at the object of providing an aircraft component equipped with such a fastening device and of specifying a method for connecting such an aircraft component to a further aircraft component.

A fastening device according to the invention which is suitable, in particular, for use in aircraft construction comprises a carrier which is composed of a rollable or foldable material. The material constituting the carrier has such a deformability and/or thickness that it is possible to roll up or fold up the carrier, for example, for storage and/or transportation. The carrier has a first surface, intended for abutting against a component to be connected to the fastening device, and a second surface opposite the first surface. Preferably, the carrier is of strip- or plate-shaped design, the first and the second surface of the carrier then being formed by the two mutually opposite large-area main surfaces of the carrier. In the state of the fastening device when connected to a component, in particular an aircraft component, the first surface of the carrier preferably abuts against on the component connected to the fastening device, whereas the second surface of the carrier faces away from the component connected to the fastening device.

A plurality of openings is formed in the carrier, the openings passing through the carrier from its first to its second surface. If the carrier is of strip-shaped design, the openings passing through the carrier can be arranged, for example, in a manner distributed along a longitudinal axis of the carrier. The position of the opening in the carrier is preferably adapted to the position of openings which are formed in a component, in particular an aircraft component, to be connected to the fastening device. In the state when connected to the component, at least some of the openings passing through the carrier are preferably aligned with the openings provided in the component. The size and shape of the openings formed in the component and the carrier is preferably adapted to the size and shape of a screw bolt which is intended for passing through the openings formed in the component and the carrier of the fastening device to connect the component to a further component.

The fastening device according to the invention further comprises a plurality of heads which are each provided with an internal thread. The heads are connected to the carrier or formed integrally with the carrier and extend in such a manner from the second surface of the carrier that the internal threads of the heads are aligned with the openings passing through the carrier. The heads provided with an internal thread are intended for cooperation with a screw bolt in order to connect, for example, a component connected to the fastening device to a further component, as will be explained in more detail later.

The fastening device according to the invention has a plurality of heads provided with an internal thread and is therefore able to replace a plurality of anchor nuts to be individually connected to a component, in particular an aircraft component. The mounting of the fastening device on the component to be connected to the fastening device can be effected in a simple, convenient and thus less error-prone manner via the carrier of the fastening device. The fastening device according to the invention thus enables a particularly quick and simple connection of two components and is therefore advantageously usable, in particular, during the assembly of the structure of an aircraft, where at present a large number of individual anchor nuts are installed. Furthermore, the fastening device can be produced cost-effectively, stored in a space-saving manner in the rolled-up state of the carrier and easily transported.

The carrier of the fastening device can comprise a fiber body. The fiber body can contain, for example, Teflon fibers, aramid fibers and/or nylon fibers, which can be in the form of a fiber fabric or a fiber braid of a single layer or a plurality layers. The fibers of the fiber body can be formed as continuous fibers or as short fibers. Preferably, however, the fiber body contains short fibers which form a fiber tangle in which the fibers are randomly oriented in all spatial directions. If desired, the fibers contained in the fiber body of the carrier can be coated. For example, fibers coated with a curable resin or the like can be used to produce the fiber body. A carrier comprising a fiber body is distinguished by a low weight and simple producibility. A further advantage of a carrier comprising a fiber body consists in that the carrier then has a certain deformability and flexibility and consequently the heads connected to the carrier are variable in their position to a certain degree. As a result, it is possible to compensate for manufacturing and assembly tolerances in a simple and convenient manner.

In the region of its first surface, which is intended for abutting, in the state of the fastening device when connected to a component, in particular an aircraft component, against the component connected to the fastening device, the carrier is preferably provided, at least in sections, with an adhesive layer. The carrier of the fastening device and consequently the fastening device as a whole can then be connected to the component in a simple manner by adhesive bonding. The carrier of the fastening device according to the invention has a significantly larger adhesive surface compared with an individual anchor nut. The adhesive-bonded connection can therefore be made sufficiently secure even if a less strong adhesive is used. Moreover, the carrier can be detached from the component again more easily than an anchor nut adhesively bonded to a component individually, whereby assembly errors can be more easily rectified. If desired, the carrier can be provided, in the sections of its first surface provided with an adhesive layer, additionally with a covering film covering the adhesive layer. The covering film is preferably designed such that it can be easily detached from the adhesive layer.

At least some of the heads of the fastening device provided with an internal thread preferably comprise a base plate cooperating with the second surface of the carrier. The base plate can be used to fix the heads provided with an internal thread to the second surface of the carrier. The heads provided with an internal thread can be rigidly connected to the base plate or formed integrally with the base plate. Alternatively to this, however, it is also possible to mount the sections of the heads provided with an internal thread in a floating manner on the base plates. As a result, the heads are variable in their position to a certain degree, so that manufacturing and assembly tolerances can be compensated for.

At least some of the heads provided with an internal thread can be adhesively bonded to the second surface of the carrier. In principle, it is possible to adhesively bond the heads provided with an internal thread directly to the second surface of the carrier. Preferably, however, a base plate of the heads is utilised to produce the adhesive-bonded connection between the sections of the heads provided with an internal thread and the second surface of the carrier. As a result, the usable adhesive surface is increased.

Alternatively or additionally to this, at least some of the heads of the fastening device according to the invention provided with an internal thread can be provided with barbs which cooperate with the second surface of the carrier in order to fix the heads provided with an internal thread to the carrier. Heads provided with barbs are particularly well suited for fastening to a carrier which comprises a fiber body, in particular a fiber body with short fibers oriented in all spatial directions. The barbs can be directly attached to the heads provided with an internal thread. Preferably, however, the barbs are attached to base plates of the heads. As a result, a larger-area distribution of the barbs and thus a secure fastening of the heads to the second surface of the carrier become possible.

Furthermore, in the case of the fastening device according to the invention, at least some of the heads provided with an internal thread can be formed by regions of the carrier which have been subjected to a local temperature treatment and/or shaping treatment. For example, in the case of a carrier comprising a fiber body, the heads provided with an internal thread can be formed by regions of the carrier which have been locally heated to such a temperature that the fibers of the fiber body and/or surface layers applied to the fibers of the fiber body at least partially melt, agglomerate, stick together and/or harden and thereby form a carrier region which has a greater density and/or strength than the surrounding carrier regions. The local temperature treatment of the carrier can be accompanied by a local shaping treatment which can serve, for example, to introduce an internal thread into the heads.

For example, at least some of the heads provided with an internal thread can be formed by regions of the carrier which have been subjected to a local temperature treatment and/or shaping treatment by screwing a screw, heated to an elevated temperature, into the carrier. For example, the screw can be heated to a temperature which is sufficiently high to ensure an at least partial melting, agglomeration, sticking together and/or hardening of fibers contained in a fiber body of the carrier and/or surface layers present on the fibers. As a result of the external thread of the screw, furthermore, an internal thread can be simultaneously produced in a simple manner.

In the case of a method according to the invention for producing a fastening device which is suitable, in particular, for use in aircraft construction, there is provided a carrier which is composed of a rollable or foldable material and has a first surface, intended for abutting against a component to be connected to the fastening device, and a second surface opposite the first surface. A plurality of openings is formed in the carrier and the openings pass through the carrier. Furthermore, the carrier is provided with a plurality of heads, each provided with an internal thread, which are connected to the carrier or formed integrally with the carrier and which extend in such a manner from the second surface of the carrier that the internal threads of the heads are aligned with the openings passing through the carrier.

The carrier can comprise a fiber body which contains, in particular, Teflon fibers, aramid fibers and/or nylon fibers. If desired, the fibers contained in the fiber body can be provided with a suitable surface layer, for example made of a curable resin or the like. The carrier can be provided in the region of its first surface, at least in sections, with an adhesive layer.

At least some of the heads provided with an internal thread can comprise a base plate cooperating with the second surface of the carrier. The base plate can serve to mount the sections of the heads provided with an internal thread in a floating manner and thereby simplify the compensation for tolerances. Additionally or alternatively to this, the base plate can fix the sections of the heads provided with an internal thread to the carrier of the fastening device.

At least some of the heads provided with an internal thread can be adhesively bonded to the second surface of the carrier. Alternatively or additionally, at least some of the heads provided with an internal thread can be provided with barbs which cooperate with the second surface of the carrier in order to fix the heads provided with an internal thread to the carrier.

To form at least some of the heads provided with an internal thread, regions of the carrier can be subjected to a local temperature treatment and/or shaping treatment. For example, to form at least some of the heads provided with an internal thread, regions of the carrier can be subjected to a local temperature treatment and/or shaping treatment by screwing a screw, heated to an elevated temperature, into the carrier.

An aircraft component according to the invention has a plurality of openings passing through the aircraft component and suitable for receiving screw bolts for connecting the aircraft component to a further aircraft component. An above-described fastening device is fastened to the aircraft component in such a manner that the heads of the fastening device provided with an internal thread are aligned with the openings formed in the aircraft component.

In the case of a method according to the invention for connecting an above-described aircraft component to a further aircraft component, firstly the above-described aircraft component and the further aircraft component are positioned in such a manner relative to one another that an opening formed in the further aircraft component and suitable for receiving a screw bolt for connecting the further aircraft component to the above-described aircraft component is aligned with one of the openings formed in the above-described aircraft component. Furthermore, a screw bolt is passed through the openings formed in the further aircraft component and the above-described aircraft component. Finally, the screw bolt is screwed to the internal thread of a head of the fastening device, the head of the fastening device being centered in its position relative to the opening formed in the above-described aircraft component by cooperation with the screw bolt. As a result, it is possible to effectively compensate for manufacturing and assembly tolerances.

On screwing the screw bolt to the internal thread of a head of the fastening device, barbs provided on the head of the fastening device can catch in the second surface of the carrier. In the case of such a configuration, on screwing the screw bolt to the internal thread of a head of the fastening device, the head of the fastening device is simultaneously fixed to the second surface of the carrier.

### BRIEF DESCRIPTION OF THE DRAWINGS

Preferred embodiments of the invention will now be explained in more detail with reference to the appended schematic drawings, of which

FIGS. 1a and 1b show a first embodiment of a fastening device suitable for use in aircraft construction in a plan view and a cross-sectional view,

FIG. 2 illustrates the production of a second embodiment of a fastening device suitable for use in aircraft construction in a cross-sectional view,

FIGS. 3a and 3b illustrate the production of a third embodiment of a fastening device suitable for use in aircraft construction in a plan view and a cross-sectional view,

FIG. 4 shows a fastening device according to FIGS. 1 to 3 in a rolled state,

FIG. 5 shows a cross-sectional view of an aircraft component, to which a fastening device according to FIG. 2 is fastened, and

FIG. 6 shows the connection of the aircraft component according to FIG. 5 to a further aircraft component in a cross-sectional view.

### DETAILED DESCRIPTION OF THE PREFERRED EMBODIMENTS

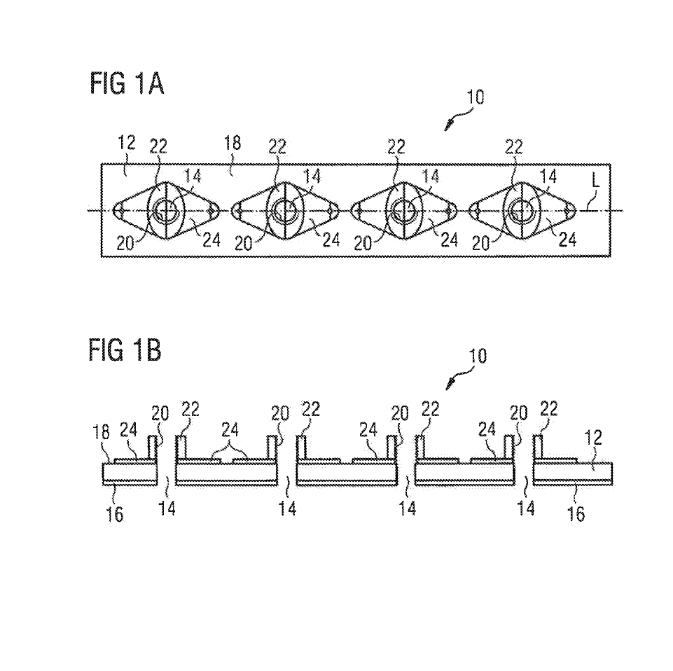

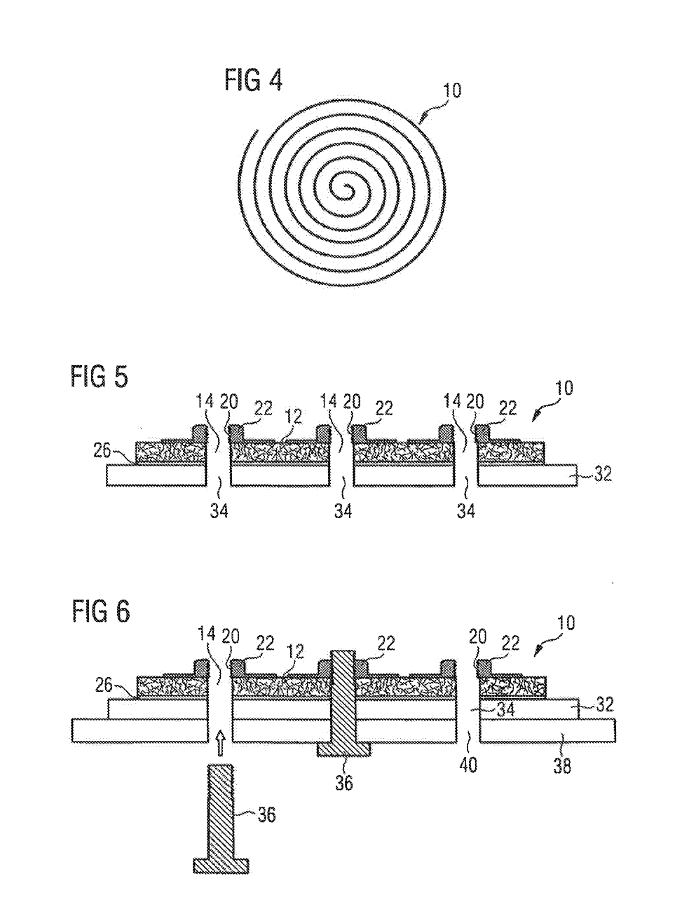

FIGS. 1a and 1b show a fastening device 10 which is suitable, in particular, for use during the assembly of the structure of an aircraft. The fastening device 10 comprises a carrier 12, which is composed of a rollable or foldable material, so that the carrier 12 can be stored and/or transported in a rolled state, as illustrated in FIG. 4. In the case of the fastening device 10 illustrated in FIG. 1, the carrier 12 is composed of a fabric tape which is provided with a plurality of openings 14 along its longitudinal axis L. The openings 14 pass through the carrier 12 completely from a first surface 16 to a second surface 18.

The first surface 16 of the carrier 12 is intended for abutting against on a component to be connected to the fastening device 10. By contrast, heads 22 provided with an internal thread 20 extend from the second surface 18 of the carrier 12. The heads 22 are positioned in such a manner relative to the carrier 12 that the internal threads 20 formed in the heads 22 are aligned with the openings 14 passing through the carrier 12. The heads 22 each comprise a base plate 24. The sections of the heads 22 provided with the internal thread 20 and extending from the second surface 18 of the carrier 12 are each mounted in a floating manner on a base plate 24. By contrast, the base plates 24 are rigidly connected to the second surface 18 of the carrier 12 by an adhesive-bonded connection.

In the region of its first surface 16, the carrier 12 is provided with an adhesive layer 26. When the fastening device 10 is not connected to a component, the adhesive layer 26 is covered by a covering film (not illustrated in the figures). The covering film can, however, also be pulled off the adhesive layer 26 in a simple manner, so that the fastening device 10 can be fastened to a component in a simple manner via the adhesive layer 26 applied to the first surface 16 of the carrier 12.

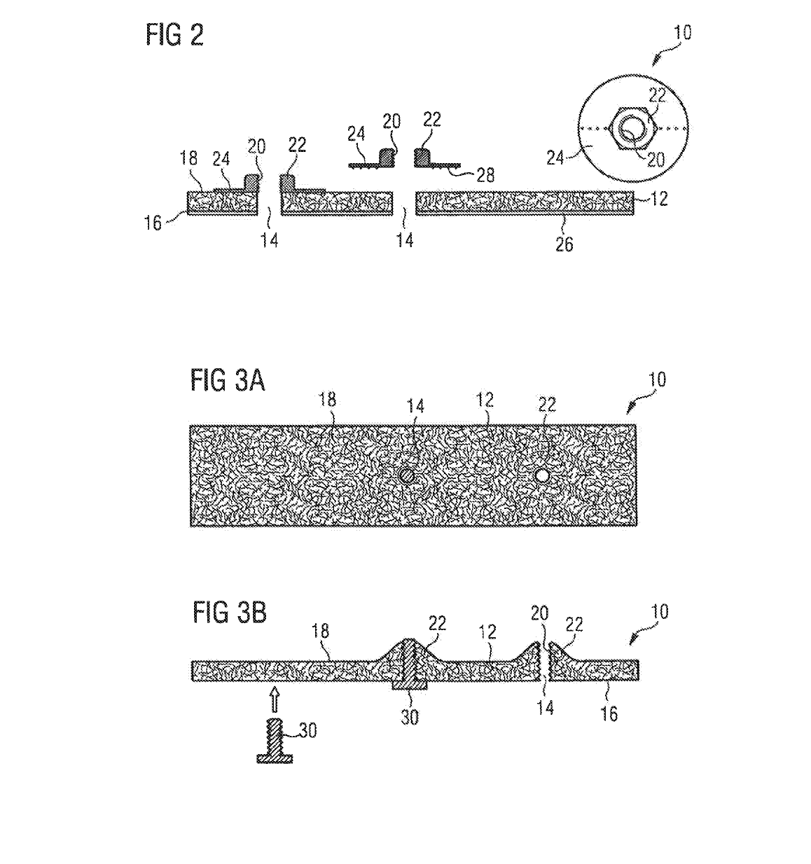

A second embodiment of a fastening device 10, illustrated in FIG. 2, differs from the arrangement according to FIGS. 1a and 1b firstly in that the carrier 12 is no longer composed of a fabric tape, but comprises a fiber body which contains short fibers randomly oriented in all spatial directions. For example, the fiber body of the carrier 12 can contain Teflon fibers, aramid fibers and/or nylon fibers, it being possible for the fibers additionally also to be provided with a surface coating, for example made of a curable resin material or the like, if required.

Similar to the arrangement according to FIGS. 1a and 1b , the heads 22 of the fastening device 10 which are provided with an internal thread 20 each have a base plate 24. The sections of the heads 22 provided with the internal thread are now, however, rigidly fastened to the respective base plates 24 or formed integrally with the base plates 24. The fastening of the heads 22 to the carrier 12 is effected by barbs 28 which extend from a surface of the base plates 24 facing the second surface 18 of the carrier 12. The barbs 28 catch on the fibers of the carrier 12 and thus ensure a secure fastening of the heads 22 to the carrier 12. In other respects, the construction of the fastening device 10 illustrated in FIG. 2 corresponds to the construction of the arrangement according to FIGS. 1a and 1b.

A further embodiment of a fastening device 10 is shown in FIGS. 3a and 3b. As with the arrangement according to FIG. 2, the fastening device 10 illustrated in FIGS. 3a and 3b also comprises a carrier 12 with a fiber body which contains short fibers randomly oriented in all spatial directions. The heads 22 provided with an internal thread 20 are, however, no longer formed by separate components fastened to the carrier 12, but are formed integrally with the carrier 12.

As illustrated in FIG. 3b, the heads 22 are formed by screwing a screw 30, heated to an elevated temperature, into the carrier 12. The screw 30 is heated to such a temperature that the fibers of the carrier 12, and/or surface layers applied to the fibers of the carrier 12, locally melt, harden and/or agglomerate and thereby produce the regions of the carrier 12 forming the heads 22, which are distinguished by an increased density, hardness and/or strength compared with surrounding regions of the carrier 12. In other respects, the construction of the fastening device 10 shown in FIGS. 3a and 3b corresponds to the construction of the arrangement according to FIG. 2.

FIG. 5 shows an aircraft component 32, to which a fastening device 10 according to FIG. 2 is fastened. The aircraft component 32 has a plurality of openings 34 passing through the aircraft component 32. As can best be seen in FIG. 6, the openings 34 formed in the aircraft component 32 are suitable for each receiving a screw bolt 36 which serves to connect the aircraft component 32 to a further aircraft component 38. For this purpose, the further aircraft component 38 is also provided with openings 40, through each of which a screw bolt 36 passes. The fastening device 10 is fastened to the aircraft component 32 in such a manner that the heads 22 of the fastening device 10 provided with an internal thread 20 are aligned with the openings 34 formed in the aircraft component 32.

In order to connect the aircraft component 32 to the further aircraft component 38, the components 32, 38 are firstly positioned in such a manner relative to one another that the openings 34, 40 formed in the components 32, 38 are aligned with one another, as shown in FIG. 6. Subsequently, a screw bolt 36 is passed through each of the openings 34, 40 and screwed to the internal thread 20 of a head 22 of the fastening device 10. Since the carrier 12 comprising a fiber body has a certain flexibility, the heads 22 of the fastening device 10 are centered in their position relative to the openings 34, 40 formed in the aircraft components 32, 38 on cooperation with the screw bolt 36. Moreover, the barbs 28 provided on the heads 22 catch in the second surface 18 of the carrier 12 of the fastening device 10, whereby the heads 22 are securely fixed to the carrier 12 of the fastening device.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. A fastening device which is suitable, in particular, for use in aircraft construction and comprises:
a carrier which is composed of one of a rollable and foldable material and has a first surface, intended for abutting against a component to be connected to the fastening device, and a second surface opposite the first surface, a plurality of openings being formed in the carrier and passing through the carrier, and
a plurality of heads, each provided with an internal thread, which are one of connected to the carrier and formed integrally with the carrier, and which extend in such a manner from the second surface of the carrier that the internal threads of the heads are aligned with the openings passing through the carrier.

2. The fastening device according to claim 1, wherein the carrier comprises a fiber body which contains at least one of Teflon fibers, aramid fibers and nylon fibers.

3. The fastening device according to claim 1, wherein the carrier is provided, in the region of its first surface, at least in sections, with an adhesive layer.

4. The fastening device according to claim 1, wherein at least some of the heads provided with an internal thread comprise a base plate cooperating with the second surface of the carrier.

5. The fastening device according to claim 1, wherein at least some of the heads provided with an internal thread are adhesively bonded to the second surface of the carrier.

6. The fastening device according to claim 1, wherein at least some of the heads provided with an internal thread are provided with barbs which cooperate with the second surface of the carrier in order to fix the heads provided with an internal thread to the carrier.

7. The fastening device according to claim 1, wherein at least some of the heads provided with an internal thread are formed by regions of the carrier which have been subjected to at least one of a local temperature treatment and a shaping treatment.

8. The fastening device according to claim 7, wherein at least some of the heads provided with an internal thread are formed by regions of the carrier which have been subjected to at least one of a local temperature treatment and a shaping treatment by screwing a screw, heated to an elevated temperature, into the carrier.

9. A method for producing a fastening device for use in aircraft construction having the steps:
providing a carrier which is composed of one of a rollable and foldable material and has a first surface, intended for abutting against a component to be connected to the fastening device, and a second surface opposite the first surface,
forming a plurality of openings in the carrier and passing through the carrier, and
providing the carrier with a plurality of heads, each provided with an internal thread, which are one of connected to the carrier and formed integrally with the carrier, and which extend in such a manner from the second surface of the carrier that the internal threads of the heads are aligned with the openings passing through the carrier.

10. The method according to claim 9, wherein the carrier comprises a fiber body which contains at least one of Teflon fibers, aramid fibers and nylon fibers.

11. The method according to claim 9, wherein the carrier is provided in the region of its first surface, at least in sections, with an adhesive layer.

12. The method according to claim 9, wherein at least some of the heads provided with an internal thread comprise a base plate cooperating with the second surface of the carrier.

13. The method according to claim 9, wherein at least some of the heads provided with an internal thread are adhesively bonded to the second surface of the carrier.

14. The method according to claim 9, wherein at least some of the heads provided with an internal thread are provided with barbs which cooperate with the second surface of the carrier in order to fix the heads provided with an internal thread to the carrier.

15. The method according to claim 9, wherein regions of the carrier are subjected to at least one of a local temperature treatment and a shaping treatment in order to form at least some of the heads provided with an internal thread.

16. The method according to claim 15, wherein regions of the carrier are subjected to at least one of a local temperature treatment and a shaping treatment by screwing a screw, heated to an elevated temperature, into the carrier in order to form at least some of the heads provided with an internal thread.

17. An aircraft component having a plurality of openings passing through the aircraft component and suitable for receiving screw bolts for connecting the aircraft component to a further aircraft component, and to which a fastening device according to claim 1 is fastened in such a manner that the heads of the fastening device provided with an internal thread are aligned with the openings formed in the aircraft component.

18. The method for connecting the aircraft component according to claim 17 to a further aircraft component, in which
the aircraft component and the further aircraft component are positioned in such a manner relative to one another that an opening formed in the further aircraft component and suitable for receiving a screw bolt for connecting the further aircraft component to the aircraft component is aligned with one of the openings formed in the aircraft component,
a screw bolt is passed through the openings formed in the further aircraft component and the aircraft component, and
the screw bolt is screwed to the internal thread of a head of the fastening device, the head of the fastening device being centered in its position relative to the opening formed in the aircraft component by cooperation with the screw bolt.

19. The method according to claim 18, wherein, on screwing the screw bolt to the internal thread of a head of the fastening device, barbs provided on the head of the fastening device catch in the second surface of the carrier.
